(19) United States
(12) Patent Application Publication
(10) Pub. No.: US 2007/0119695 A1
(43) Pub. Date: May 31, 2007

(54) Signal switching apparatus for electronic device

(75) Inventors: Xin-Jie Miao, Taipei (TW); Yung-Chi Yang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/263,711

(22) Filed: Oct. 31, 2005

(51) Int. Cl. H01H 9/28

(52) U.S. Cl. 200/43.01

(57) ABSTRACT

A signal switching apparatus for electronic device is proposed. The switching apparatus includes a switching component, provided in the electronic device, having a control unit for switching the on/off condition of signals, and an operating component having an operating unit exposed from the electronic device and a connecting unit extending to the inside of the electronic device and coupled to the control unit.

### BACKGROUND OF THE INVENTION

1. Field of the Invention

The present invention relates generally to signal switching devices and, more particularly, to a signal switching apparatus for an electronic device.

2. Description of Related Art

With increasing progress of science and technology, electronic products have been widely used in life, especially various kinds of portable electronic devices such as notebook computers can even satisfy the present requirements of consumers for lightness, thinness, smallness, multi-function, and user-friendliness. Therefore, portable electronic devices stood out from various kinds of electronic products. However, the overall size of an electronic device has become smaller, so the space that can be allocated to an apparatus for controlling signal switching in the electronic device is also constrained. Accordingly, the size of the signal switching apparatus must be shrunk to as small as possible.

As shown in FIG. 1, a conventional signal switching apparatus of a portable electronic device comprises a switching component 1 provided on the main circuit board in the electronic device, a first member 2 and a second member 3 that are rigidly coupled with each other. The switching component 1 has a control unit 11 for switching on/off status of signals. The first member 2 which is assembled to a casing 4 of the electronic device comprises an operating unit 21 exposed from the electronic device allowing user' operations. The second member 3 is disposed between the first member 2 and the switching component 1, one end of the second member 3 is fixed with the first member 2, and the other end is cooperated with the control unit 11 of the switching component 1 for driving the control unit 11.

The above-discussed first member 2 is assembled On the sidewall of the casing 4 of the electronic device, on which a penetrating opening 41 is correspondingly provided. When assembling the first member 2 with the second member 3, the first member 2 is entered into the electronic device from outside of the sidewall through the opening 41, and the second member 3 is fixed with the first member 2 at the inside of the sidewall. Since the first member 2 is fixed with the second member 3, so when the operating unit 21 of the first member 2 is actuated, the first member 2 and the second member 3 move as a whole, and the control unit 11 is correspondingly driven to move by the cooperation of the second member 3 and the switching component 1, thereby attain the function of signal switch.

In this conventional design of signal switching apparatus, the first member 2 is assembled to the sidewall of the electronic device in an outside-to-inside manner, making the area of the operating unit 21 relatively large to facilitate operations of the users, while making the portion of the first member 2 extending to the inside of the electronic device too small to be directly cooperated with the control unit 11 of the switching component 1. As such, an intermediate component, i.e., the second member 3, has to be used in order for the first member I to couple to the control unit 11. Therefore, the necessary components of signal switching apparatus is inevitably increased, which consequently increases the cost of the electronic device. Furthermore, the inner space of the electronic device is limited, and the space occupied by this signal switching apparatus is relatively large, which must directly affect the freedom of inner layout design of the electronic device, making it difficult to adapt to miniaturization of the electronic devices.

Accordingly, there exists a strong need to solve the drawbacks of the conventional signal switching apparatus, such as. complex structure, high cost and difficulties in inner design of the electronic device and in miniaturization.

### SUMMARY OF TE INVENTION

Accordingly, it is an objective of the present invention to solve the aforementioned drawbacks of the conventional technology by providing a signal switching apparatus with simple structure for an electronic device.

It is another objective of the present invention to provide a signal switching apparatus for an electronic device which increases the freedom of layout design in the electronic device.

It is a further objective of the present invention to provide a signal switching apparatus for an electronic device that allows the size of the electronic device to be reduced.

In order to attain the abovementioned and other objectives, a signal switching apparatus for electronic device is provided according to the present invention, which comprises: a switching component and an operating component, the switching component is provided in the electronic device, and has a control unit for switching the condition of a signal; the operating component has an operating unit exposed from the electronic device and a connecting unit extending to the inside of the electronic device and coupled to the control unit.

The connecting unit of the aforementioned operating component extends from the operating unit to one side of the switching component, the operating component has a connecting unit for cooperating with the switching component of the electronic device and an operating unit exposed from the electronic device for user operation. The operating unit further includes maintaining structures for allowing the operating component to freely slide on the electronic device. The connecting unit is a pair of rectangular blocks, and a compartment is disposed between the pair of the rectangular blocks for receiving the control unit. The connecting unit further includes strengthening structures, wherein the strengthening structures are a pair of triangular blocks respectively abutting against the corresponding rectangular blocks.

The signal switching apparatus for an electronic device according to the present invention comprises the switching component and the operating component, when compared with the conventional technology, the present invention has less components, simpler structure, reduced cost, and higher inner layout design and smaller size of the electronic device.

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

### BRIEF DESCRIPTION OF DRAWINGS

FIG. 1 depicts a stereogram of a signal switching apparatus for a conventional electronic device.

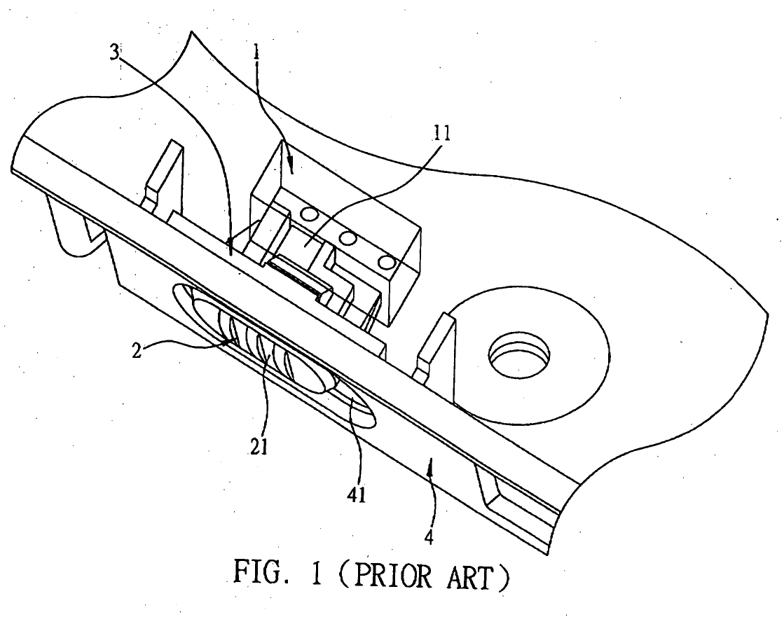

FIG. 2 depicts a stereogram of a signal switching apparatus for an electronic device according to the present invention.

FIG. 3 depicts a stereogram of the signal switching apparatus for an electronic device according to the present invention from another angle.

### DETAILED DESCRIPTION OF PREFERRED EMBODIMENTS

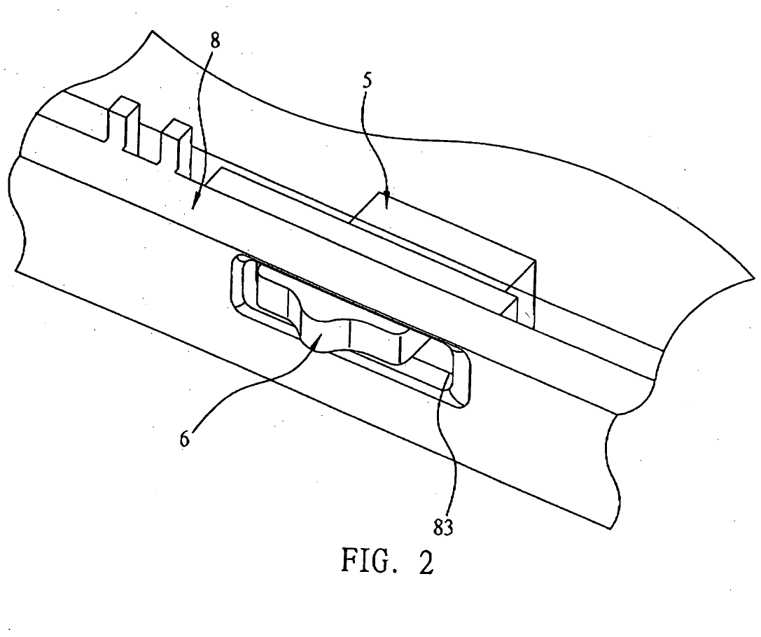

With reference to FIG. 2, the signal switching apparatus according to the present invention can be provided at a side of the electronic device, wherein a notebook computer is used an example of an electronic device, but it is apparent to those skilled in the art that the present invention can also be applied in other electronic devices, so it is not limited to this. In addition, in order to. facilitate a better understanding of description, only those of the electronic. device pertained to the present invention in the following embodiment will be illustrated.

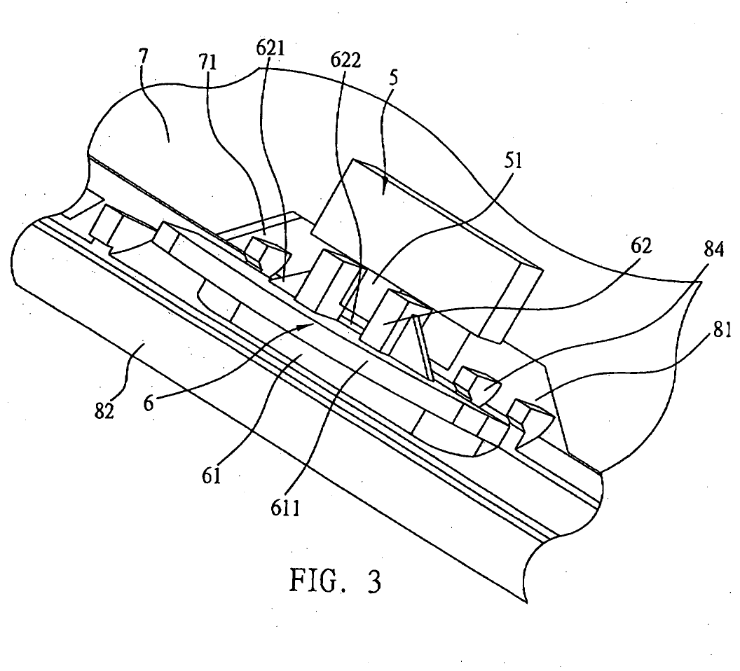

Referring to FIG. 2 in conjunction with FIG. 3, the signal switching apparatus for electronic device according to the present invention comprises a switching component 5 and an operating component 6.

The switching component 5 is provided inside the electronic device, and comprises a control unit 51 protruding from a side surface of the switching component 5. The control unit 51 is a rectangular block that can be moved -between a first position and a second position of the switching component 5 to switch the on/off condition of signals. The first position and the second position of the switching component are conventional features, so they will not be described in detail.

The operating component 6 comprises an operating unit 61 and a connecting unit 62. The operating unit 61 is exposed from the electronic device to allow the users to control (i.e. switch) the on/off condition of signals, and further includes maintaining structure 611 for maintaining the operating component 6 to freely slide on the electronic device. The connecting unit 62 extending from the maintaining structure 611 to one side of the switching component 5 is composed of a pair of rectangular blocks. Between the pair of rectangular blocks is a compartment 622, the size of the compartment 622 is substantially equal to the size of the control unit 51 for receiving the compartment 622 therein, thereby coupling the operating component 6 with the switching component 5. In addition, the connecting unit 62 further includes strengthening structures 622, the strengthening structures 622 are a pair of triangular blocks abutting against the corresponding connecting units 62 for strengthening geometric stability of the connecting units 62 and assuring the efficiency of the overall signal switching apparatus during operations by the users.

The aforementioned operating component cooperates with the control unit protruding from one side of the switching component via the connecting unit having the compartment. It should be noted that, if the connecting unit is a single block rather than two separate rectangular blocks, and the block has an opening with a size equal to that of the control unit to fully receive the control unit, it is still feasible to cooperate the operating component to the control unit. Furthermore, the cooperation between the aforementioned switching component and operating component is illustrated through inserting the control unit into the compartment of the connecting unit. Alternatively, the cooperation between the control unit and the connecting unit can be achieved by clasping. It is apparent that the cooperation of the switching component and the operating component is not limited to the above-discussed structures.

With additional reference to FIG. 3, the switching component 5 is fixed on the main circuit board 7 of the electronic device. The side of the main circuit board 7 dents inwards to form an active region 7. The control unit 51 of the switching component 5 extends into the active region 71.

The operating component 6 is assembled to the casing of the electronic device. The casing includes a base 81 and a sidewall 82. The sidewall 82 provides a penetrating opening 83. In addition, at least a pair of stoppers 84 is extended upwards from the base 81 to limit the moving range of the operating component 6.

When connecting the operating component 6 to the switching component 5, the operating component 6 can be aimed at the opening 83 of the sidewall 82 and assembled to the casing in a inside-to-outside manner, so as to cause the operating unit 61 of the operating component 6 to be exposed from the opening 83 for operating. The maintaining structure 611 is housed between the main circuit board 7 and the sidewall 82 to allow the operating component 6 to freely slide on the electronic device. The connecting unit 62 enters into the active region 71 and connects to the control unit 52 of the switching component 5. Accordingly, assembly of the signal switching apparatus can be completed. At this point, actuating the operating unit 61 of the operating component 6 would make the connecting unit 62 drive the control unit 51 to move between the first position and the second position of the switching component 5, so as to switch on/off the signals.

As described above, the signal switching apparatus for electronic device according to the present invention comprises a switching component and an operating component. In comparison to the conventional technology, the intermediate second member is eliminated, cost can be relatively reduced, the freedom of layout design in the electronic device can be increased, and size of the electronic device to which the signal switching apparatus is applied can also be reduced. Therefore, the signal switching apparatus for an electronic device according to the present invention can satisfy the consumer's pursuit of the trend such as lightness, thinness and shortness, and has improved effects and high industrial applicability.

The above-descried descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A signal switching apparatus for an electronic device, comprising:
a switching component provided in the electronic device including a control unit for switching the status of a signal; and
an operating component having an operating unit exposed from the electronic device and a connecting unit extending to the inside of the electronic device and coupled to the control unit.

2. The signal switching apparatus of claim 1, wherein the control unit protrudes from a side surface of the switching component.

3. The signal switching apparatus of claim 1, wherein the connecting unit extends from the operating component to a side of the switching component.

4. The signal switching apparatus of claim 1, wherein the operating unit further includes a maintaining structure for allowing the operating component to freely slide on the electronic device.

5. The signal switching apparatus of claim 1, wherein the connecting unit is a pair of rectangular blocks, and a compartment is disposed between the pair of rectangular blocks for cooperating with the control unit.

6. The signal switching apparatus of claim 1, wherein the connecting unit further includes at least one strengthening structure.

7. The signal switching apparatus of claim 6, wherein the at least one strengthening structure is a triangular block abutting against the corresponding connecting unit.

8. The signal switching apparatus of claim 1, wherein the switching component is fixed on a main circuit board of the electronic device, a side of the main circuit board dents inwards to form an active region, the control unit of switching component extends into the active region.

9. The signal switching apparatus of claim 1, wherein the operating component is assembled to a casing of the electronic device, the casing includes a base and a sidewall, the sidewall provides a penetrating opening for exposing the operating component of the operating unit, and the base comprises at least one protruding stopper for limiting the moving range of the operating component.
